(19) United States
(12) Patent Application Publication
(10) Pub. No.: US 2010/0081394 A1
(43) Pub. Date: Apr. 1, 2010

(54) COMMUNICATION APPARATUS AND METHOD AND PROGRAM FOR CONTROLLING COMMUNICATION APPARATUS

(75) Inventor: Hiroshi Mashimo, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/566,381

(22) Filed: Sep. 24, 2009

(30) Foreign Application Priority Data
Sep. 26, 2008 (JP) 2008-248072

(51) Int. Cl. H04B 7/00

(52) U.S. Cl. 455/70

(57) ABSTRACT

In a communication apparatus, information is acquired that indicates a reception start timing of a signal transmitted by a first apparatus according to a first wireless communication method, and a signal is transmitted to a second apparatus capable of performing communication according to a second wireless communication method different from the first wireless communication method thereby controlling the second apparatus not to transmit a signal according to the second wireless communication method during a period including the reception start timing indicated by the acquired information.

### BACKGROUND OF THE INVENTION

1. Field of the Invention

The present invention relates to a technique to avoid interference between a plurality of wireless communications.

2. Description of the Related Art

There are known techniques to avoid mutual interference between wireless communications that use the same frequency band. For example, in one known technique for an apparatus having both a wireless LAN communication capability and a Bluetooth communication capability, an offset period is provided between the start of a Bluetooth communication period and the start of a wireless LAN communication period, and wireless LAN communication is inhibited during the offset period. Another technique avoids interference in wireless LAN communication between communication according to a HT method using a two-channel frequency band and communication according to a legacy method using one-channel frequency band. Note that HT stands for High Throughput. More specifically, in the latter technique, when an apparatus transmits a signal according to the HT method, the apparatus transmits a CTS signal according to the legacy method in each of two channels used in the HT method thereby avoiding interference. Note that CTS stands for Clear to Send.

As described above, when a plurality of wireless communications using the same frequency band are performed by communication units disposed in the same single case, interference is avoided by inhibiting a simultaneous occurrence of transmission in the plurality of wireless communications.

### SUMMARY OF THE INVENTION

However, in the known techniques, no consideration is given to a situation in which a plurality of signals according to different methods are simultaneously received by an apparatus having a capability of performing communication according to a plurality of wireless communication methods. In such a situation, one signal being received can function as noise to another signal being simultaneously received, and thus degradation in reception quality can occur.

In view of the above, the present invention provides a technique to increase reception performance for a signal with higher priority in a situation in which a plurality of signals according to a plurality of communication methods are received simultaneously by an apparatus.

According to an embodiment of the present invention, there is provided a communication apparatus including an acquisition unit configured to acquire information indicating a reception start timing of a signal transmitted by a first apparatus according to a first wireless communication method, and a transmission unit configured to transmit a signal to a second apparatus capable of performing communication according to a second wireless communication method different from the first wireless communication method whereby the signal controls the second apparatus not to transmit a signal according to the second wireless communication method during a period including the reception start timing indicated by the information acquired by the acquisition unit.

In the embodiment of the invention, the signal received according to the first wireless communication method is protected from the signal according to the second wireless communication method different from the first wireless communication method, thereby achieving improvement in reception performance for the signal received according to the first wireless communication method.

Further features of the present invention will become apparent from the following description of exemplary embodiments with reference to the attached drawings.

### BRIEF DESCRIPTION OF THE DRAWINGS

FIG. 1 is a diagram illustrating a wireless communication system according to an embodiment of the present invention.

FIG. 2 is a block diagram illustrating an internal structure of a combination apparatus.

FIG. 3 is a diagram illustrating a relationship in terms of transmission timing between a period of a WiMedia beacon transmitted by a first wireless communication unit and a period of a self CTS signal transmitted by a second wireless communication unit.

FIGS. 4A to 4C are diagrams illustrating in detail timing of a beacon period and a self CTS signal according to an embodiment of the invention.

FIG. 5 is a diagram illustrating a frame structure of a self CTS signal.

FIG. 6 is a flow chart illustrating a process performed by a combination apparatus according to an embodiment of the invention.

FIG. 7 is a diagram illustrating a relationship in terms of transmission timing between a WiMedia DRP period in a first wireless communication unit and a self CTS signal transmitted by a second wireless communication unit.

FIG. 8 is a diagram illustrating a relationship in terms of transmission timing between a self CTS signal transmitted by a second wireless communication unit and a WiMedia beacon period and a WUSB MMC packet transmitted by a first wireless communication unit.

FIG. 9 is a diagram illustrating in detail timing associated with an MMC signal and a self CTS signal.

FIG. 10 is a flow chart illustrating a process performed by a combination apparatus according to an embodiment of the invention.

FIG. 11 is a block diagram illustrating an internal structure of a combination apparatus.

### DESCRIPTION OF THE EMBODIMENTS

In a first embodiment disclosed below, transmission and reception by a second wireless communication system are disabled during a beacon period of a first wireless communication system. Note that the beacon is an example of a notification signal.

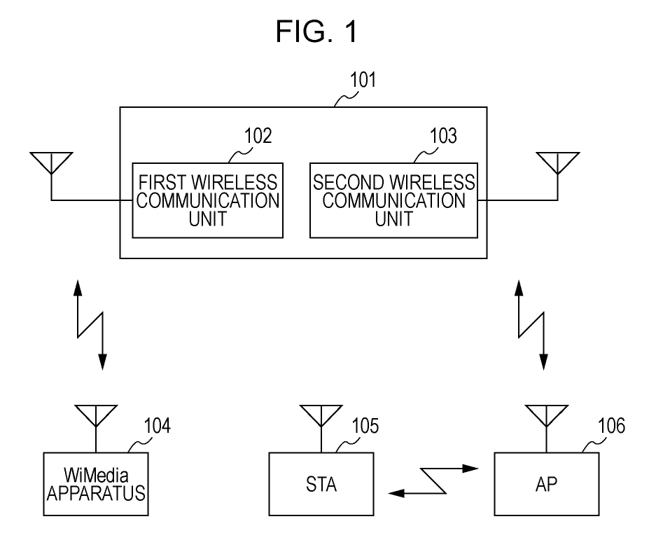

FIG. 1 illustrates a configuration in terms of connection of a wireless communication system. In FIG. 1, reference numeral 101 denotes a combination apparatus functioning as a communication apparatus including a first wireless communication unit 102 and a second wireless communication unit 103 disposed in the same single case. Specific examples of the combination apparatus 101 are a printer, a copying machine, a digital camera, a scanner, a television set, a computer, etc. The first wireless communication unit 102 and the second wireless communication unit 103 may be a communication adapter, a wireless communication circuit, etc., that are connected to or disposed in an apparatus. The connection may be removable. The first wireless communication unit 102 is a wireless communication unit configured to perform wireless communication according to the WiMedia standard. The second wireless communication unit 103 is a wireless communication unit configured to perform wireless communication according to the IEEE802.11a standard which is part of the IEEE802.11 series standard (hereinafter, the wireless communication according to the IEEE802.11a standard will also be referred to simply as wireless LAN communication). Note that IEEE stands for The Institute of Electrical and Electronics Engineers, Inc.

Reference numeral 104 denotes a first external apparatus configured to perform wireless communication according to the WiMedia standard. In the example shown in FIG. 1, the first external apparatus 104 is in a state in which it is wirelessly connected with the first wireless communication unit 102. Reference numeral 106 denotes a wireless LAN access point (AP) configured to perform wireless communication according to the IEEE802.11a standard. In the example shown in FIG. 1, the AP 106 is in a state in which it is wirelessly connected with the second wireless communication unit 103. Note that LAN stands for Local Area Network.

Reference numeral 105 denotes a wireless LAN apparatus functioning as a second external apparatus according to the IEEE802.11a standard. In the example shown in FIG. 1, the second external apparatus 105 is in a state in which it is wirelessly connected with the AP 106.

The WiMedia system used as an example of the first wireless communication system and the wireless LAN system used as an example of the second wireless communication system both use a 5-GHz band.

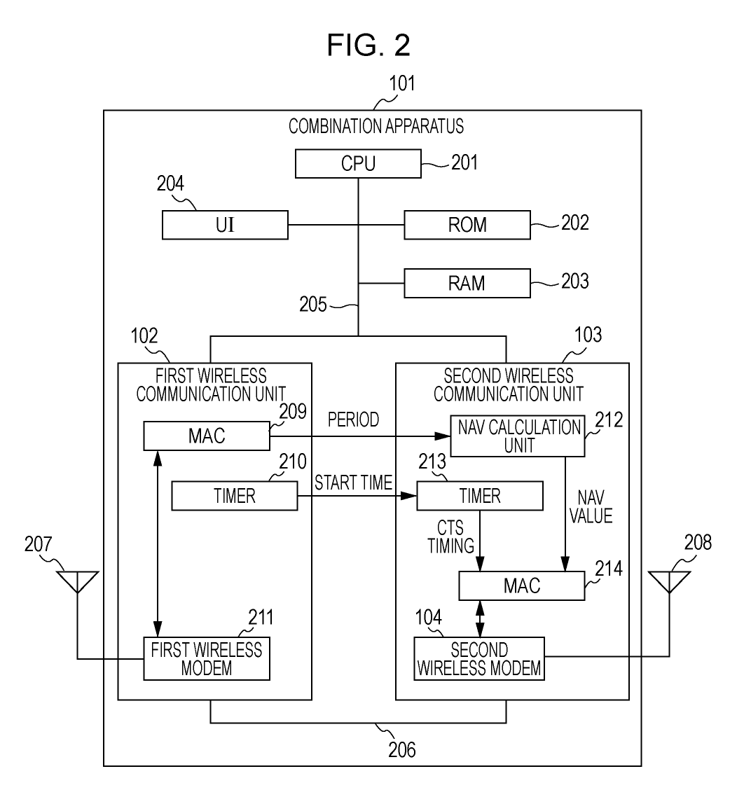

FIG. 2 illustrates an internal structure of the combination apparatus 101. In FIG. 2, reference numeral 201 denotes a CPU (Central Processing Unit) responsible for overall control of the combination apparatus 101. Reference numeral 202 denotes a memory (ROM) configured to mainly store a program for controlling an application of the combination apparatus 101. Reference numeral 203 denotes a memory (RAM) used as a work area such as a data buffer in execution of the program. Reference numeral 204 denotes a user interface (UI) including an input unit such as a button and a display such as a liquid crystal display. Reference numeral 205 denotes a bus that provides a connection among the CPU 201, the ROM 202, the RAM 203, the UI 204, the first wireless communication unit 102 and the second wireless communication unit 103. Reference numeral 206 denotes a control line via which to transmit a timing signal from the first wireless communication unit 102 to the second wireless communication unit 103. Reference numeral 207 denotes a wide-band antenna connected to the first wireless communication unit 102. This wide-band antenna 207 is configured to be operable in a frequency range from 3 GHz to 5 GHz. Reference numeral 208 denotes an antenna connected to the second wireless communication unit 103. This antenna 208 is configured to be operable in a 5 GHz band used in the wireless LAN system.

Reference numeral 209 denotes a MAC (Medium Access Control) unit configured to control assembling/disassembling of a wireless frame and transmission/reception timing according to the WiMedia standard employed as the first wireless communication method.

Reference numeral 210 denotes a timer configured to generate a wireless frame timing signal used by the MAC unit 209. The wireless frame timing signal includes information indicating a start timing of a super frame prescribed in the WiMedia standard. More specifically, the start timing of a WiMedia beacon is calculated from a start time of beacon transmission performed by the first wireless communication unit 102.

Reference numeral 211 denotes a modem having a baseband function to modulate/demodulate a wireless frame according to the WiMedia standard employed as the first wireless communication method and also having an RF function to perform a conversion between an RF signal and a baseband signal. The antenna 207 and the first wireless modem 211 are connected via an RF signal. Note that RF stands for Radio Frequency. The MAC unit 209 and the first wireless modem 211 are connected via a base band signal.

Reference numeral 212 denotes a NAV (Network Allocation Vector) calculation unit configured to calculate a transmission-inhibited period in the wireless LAN from a period of a WiMedia beacon received from the MAC unit 209.

Reference numeral 213 denotes a timer configured to generate a wireless frame timing signal used by the MAC unit 214. The timer 213 also generates a timing signal indicating timing of transmitting a self CTS (Clear to Send) signal in the wireless LAN, based on the start time of the WiMedia beacon notified from the timer 210 disposed in the first wireless communication unit. The CTS signal refers to a signal transmitted to an apparatus to control the apparatus such that the apparatus is inhibited from transmitting a packet during a period specified by a NAV value described in the CTS frame. The self CTS signal refers to a special CTS signal whose destination is set to an apparatus itself that transmits this CTS signal. If any apparatus receives a self CTS signal, the apparatus stops transmission of a packet during a period specified by a NAV value described in the self CTS signal regardless of the destination. More specifically, if a self CTS signal is received, the second wireless communication unit 103, the STA 105, and the AP 106 stop transmission of a packet during a period specified by a NAV value.

Reference numeral 214 denotes a MAC unit configured to control assembling/disassembling of a wireless frame and transmission/reception timing according to the IEEE802.11a standard employed as the second wireless communication method. When the MAC unit 214 receives a self CTS transmission timing signal from the timer 213, the MAC unit 214 starts transmitting a self CTS signal.

Reference numeral 215 denotes a modem having a baseband function to modulate/demodulate a wireless frame according to the IEEE802.11a standard employed as the second wireless communication method and also having an RF function to perform a conversion between an RF signal and a baseband signal. The antenna 208 and the second wireless modem 215 are connected via an RF signal. The MAC unit 214 and the second wireless modem 215 are connected via a base band signal.

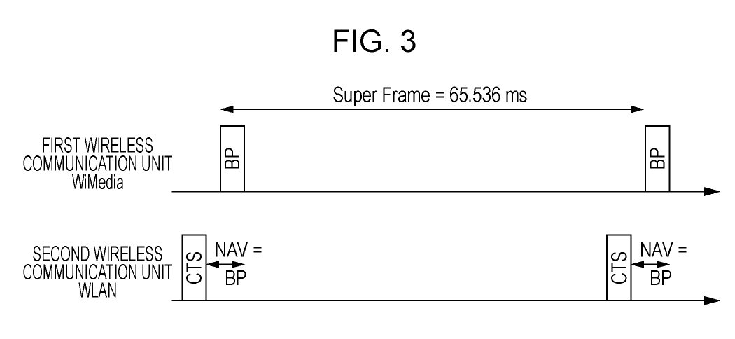

FIG. 3 illustrates a relationship in terms of timing between WiMedia beacon periods (hereinafter also referred to as BPs) in the first wireless communication unit and self CTS signals transmitted by the second wireless communication unit. The WiMedia beacon period refers to a period from a time at which transmission of a beacon is started by a first one of apparatuses that transmit beacons till a time at which transmission of beacons by all apparatuses is completed. The length of the beacon period varies from a minimum of 85.3 μs to a maximum of 8192 μs depending on the number of apparatuses that transmit beacons. In the present embodiment, it is assumed by way of example that there are only two beacon transmission apparatuses, i.e., the first wireless communication unit 102 and the WiMedia apparatus 104. In this specific case, the beacon period is equal to 85.3 μs×2=170.6 μs.

A WiMedia beacon is transmitted periodically at intervals of 65.536 ms, and a self CTS signal is transmitted immediately before each beacon. Each self CTS signal includes a NAV value indicating a period during which the wireless LAN apparatus is inhibited from performing transmission.

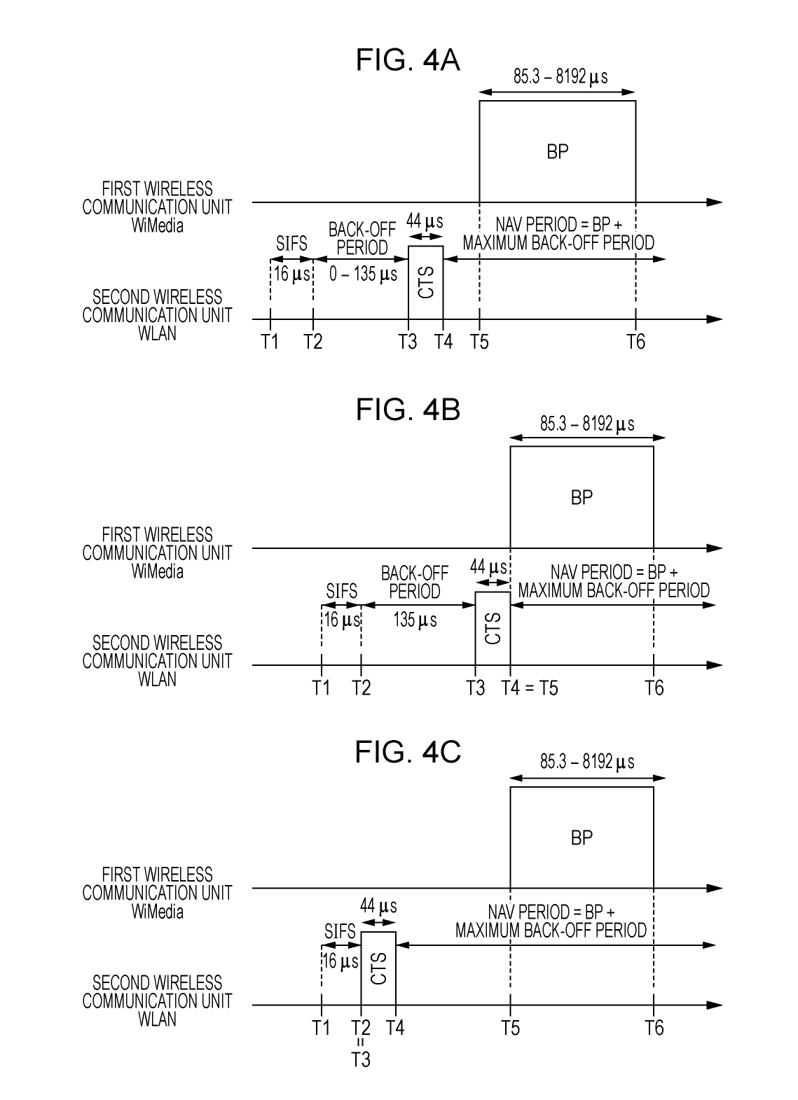

FIG. 4A illustrates details of timing associated with a beacon period and a self CTS signal. In FIG. 4A, T1 denotes a time at which the timer 213 instructs the MAC unit 214 to start preparation for transmission of a self CTS signal. Hereinafter, this point of time will also be referred to as CTS timing. T2 denotes the end of SIFS before the self CTS. Note that SIFS stands for Short Inter Frame Space prescribed in the IEEE802.11a standard. T3 denotes a time at which the MAC unit 214 starts transmission of the self CTS signal. T4 denotes a time at which the MAC unit 214 completely ends the transmission of the self CTS signal. T5 denotes a time at which the WiMedia beacon period starts (WiMedia beacon start time (reception start time)). T6 denotes a time at which the WiMedia beacon period ends (WiMedia beacon end time (reception end time)).

The timer 210 calculates the WiMedia beacon period start time T5 based on the beacon transmission time of the first wireless communication unit 102 and notifies the timer 213 of the calculated beacon period start time T5. The timer 213 calculates the time T1 based on the time T5 notified, and generates a self CTS timing signal preceding the beacon period. The method of calculating the time T1 is described in further detail below with reference to FIG. 4B. FIG. 4B illustrates a case in which the transmission of the self CTS signal shown in FIG. 4A is delayed to an extreme extent, and the back-off time before the self CTS signal is set to 9 μs×15=135 μs. Thus, in this case, T4=T5. Note that in the calculation of the back-off time, 9 μs is a slot time prescribed in the IEEE802.11a standard, and 15 is a maximum value within a range in which a random number is generated for first-time transmission according to the IEEE802.11a standard. In this case, T1 can be determined from the length of the self CTS signal at a transmission rate of 6 Mbps (i.e., T4−T3=44 μs), the maximum value of the back-off time before the transmission of the CTS signal (i.e., T3−T2=135 μs), and the SIFS time (i.e., T2−T1=16 μs). That is, T5−T1=195 μs.

By determining the time T1 in the above-described manner, it is ensured that the transmission of the self CTS signal is completed before the start time of the WiMedia beacon period even in the case where the transmission of the self CTS signal is delayed by a maximum allowable amount. That is, at the time 1, the timer 213 instructs the MAC unit 214 to start preparation for the transmission of the self CTS signal thereby ensuring that the transmission of the self CTS signal is completed before the start of the WiMedia beacon period.

Next, a method of calculating the NAV value is described below with reference to FIG. 4C. FIG. 4C illustrates a case in which the self CTS signal is transmitted at an extremely early time. More specifically, the back-off time (see FIG. 4A) before the transmission of the self CTS signal is set to 9 μs×0=0 μs and thus T3=T2. In this specific case, in order for the NAV period to include the beacon period, the NAV value is set to be equal to the sum of a value 171 μs obtained by rounding the value beacon period 170.6 μs up to the decimal point and the maximum value, 135 μs, of the back-off time before the self CTS signal, i.e., the NAV value is set to 306 μs.

By determining the NAV value in the above-described manner, the resultant NAV period always includes a beacon period, i.e., the NAV period includes a beacon period even in the case where the transmission of the self CTS signal is performed at an extremely early time. More specifically, as described above, by setting the NAV value to 306 μs which is the sum of the beacon period and the maximum back-off time, it is ensured that the NAV period includes the beacon period.

Note that the time T1 may be set to a time 195 μs or greater before the time T5 (i.e., T5−T1=δ+195 μs). In this case, the NAV value is set to δ+306 μs (δ≧0).

By setting the NAV value in the above-described manner, the resultant NAV period includes the beacon period regardless of the back-off time that is set randomly, and thus it becomes possible to disable transmission in the wireless LAN during the period including at least the WiMedia beacon period.

In the case where the counting-down by the back-off counter is temporarily stopped because the wireless channel is in use or for other reasons over a period longer than the difference between the maximum back-off value and the initial value and thus a great delay is needed in transmission of the self CTS signal, the transmission of the self CTS signal is canceled. Also in a case where when the back-off counter reaches 0, a further delay is necessary in transmission of the self CTS signal because the wireless channel is still in use or for any other reason, the transmission of the self CTS signal is canceled. Thus, the WiMedia beacon is prevented from being interfered with by transmission of the self CTS signal.

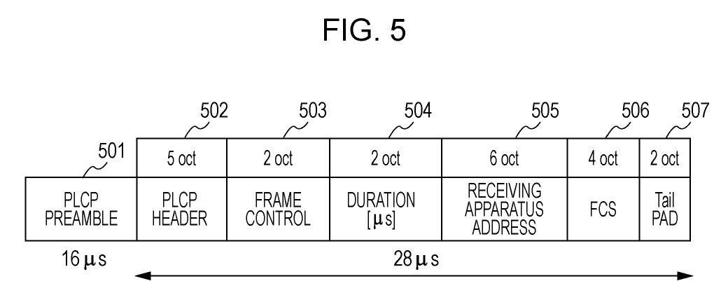

FIG. 5 illustrates a frame structure of a self CTS signal, which is one of control frames prescribed in the IEEE802.11a standard. In FIG. 5, a PLCP (Physical Layer Convergence Protocol) preamble 501 is a fixed pattern signal with a length of 16 μs used for reception synchronization. A PLCP header 502 is a field with a length of 40 bits in which a data transmission rate and a data length are described. A frame control 503 is a field with a length of 2 octets in which a frame type and other information are described. In the present specific case, this field includes information indicating that the current frame is a CTS signal. A duration 504 is a field with a length of 2 octets in which a predicted period in which the wireless channel is to be used is described as a NAV value in units of μs. A receiving apparatus address 505 is a field in which a MAC address of the receiving apparatus is described. If the MAC address of the sending apparatus is described in the receiving apparatus address 505, the resultant CTS signal is set as a self CTS signal. An FCS (Frame Check Sequence) 506 is a field used in an error check. In a field 507, 6 tail bits used in the error correction and extra bits necessary for the self CTS signal to have a total length equal to an integral multiple of symbols are described. In the case where the transmission rate is 6 Mbps, one symbol has a length of 3 octets and thus 10 bits are inserted so that the total length of the frame excluding the preamble becomes equal to an integral multiple of 3 octets. The total length excluding the preamble is 21 octets, i.e., 7 symbols, and thus the total period is 28 μs. Therefore, the total period of the CTS signal including the preamble is 44 μs.

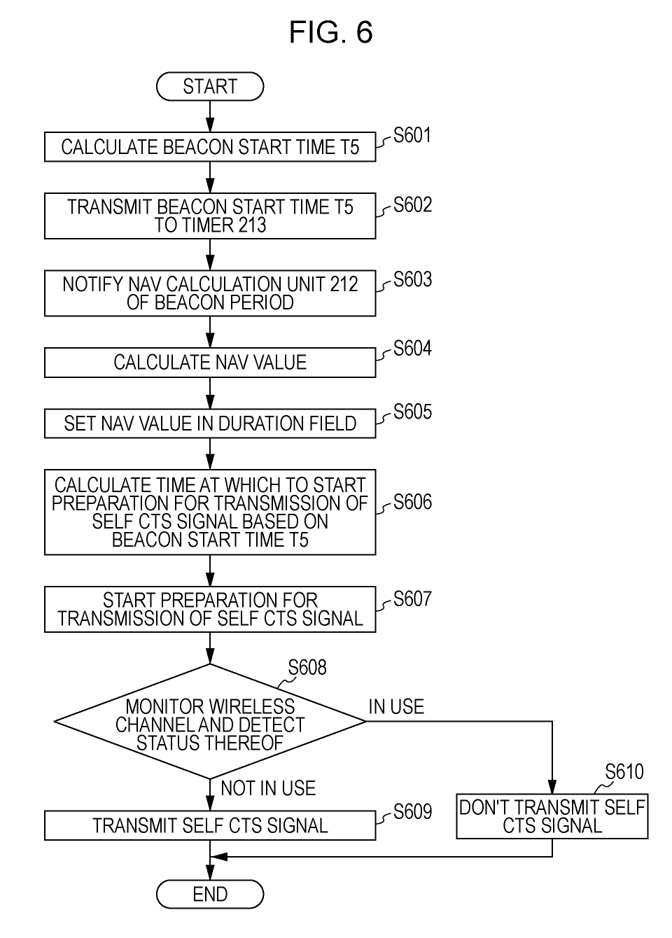

The operation of the combination apparatus 101 according to the present embodiment is described below with reference to a flow chart shown in FIG. 6. Note that the process shown in FIG. 6 is performed by the CPU 201 according to a program stored in the ROM 202. In this process, it is assumed that the combination apparatus 101 is in a state in which the first wireless communication unit 102 in the combination apparatus 101 is connected to the WiMedia apparatus 104 and the second wireless communication unit 103 is connected to the AP 106.

In step S601, under the control of the CPU 201, the timer 210 calculates the start time T5 of a WiMedia beacon period from the start time of beacon transmission performed by the first wireless communication unit 102.

In step S602, under the control of the CPU 201, the timer 210 notifies the timer 213 of the start time T5 of the WiMedia beacon period for each super frame.

In step S603, under the control of the CPU 201, the MAC unit 209 calculates the beacon period based on the number of apparatuses that perform beacon transmission, and notifies the NAV calculation unit 212 of the calculated beacon period. In the present specific case, the apparatuses that perform beacon transmission are the first wireless communication unit 102 and the WiMedia apparatus 104, and thus the number of apparatus is 2. Thus, 171 μs obtained by rounding up the 170.6 μs to the decimal point is employed as the beacon period, and this value is sent to the NAV calculation unit 212.

In step S604, under the control of the CPU 201, the NAV calculation unit 212 adds the maximum back-off value to the beacon period and employs the resultant value as the NAV value for the self CTS signal. In the present specific case, the maximum back-off value 135 μs is added to the beacon period of 171 μs, and the result value 306 μs is employed as the NAV value. Next, in step S605, under the control of the CPU 201, the NAV calculation unit 212 sets the determined NAV value in the duration field 504.

In step S606, under the control of the CPU 201, the timer 213 calculates the time T1 from the notified beacon start time T5. In the present specific case, the time T1 is determined by subtracting 195 μs from the time T5.

In step S607, under the control of the CPU 201, when the time T1 is reached, the timer 213 instructs the MAC unit 214 to start preparation for the transmission of the self CTS signal.

In step S608, under the control of the CPU 201, the MAC unit 214 monitors the status of the wireless channel used by the second wireless communication system during the back-off period that is set randomly after the SIFS period with a length of 16 μs. Herein, let us assume by way of example that the back-off time is 63 μs. If the monitoring indicates that the wireless channel is not in use, then the processing flow proceeds to step S609.

In step S609, under the control of the CPU 201, the MAC unit 214 transmits the self CTS signal. Because the self CTS signal is assigned a NAV value of 306 μs, communication with the STA 105 and the AP 106 is disabled during a period of 306 μs after the time T4 at which the transmission of the self CTS signal is completed. Thereafter, if the beacon start time T5 is reached, the WiMedia apparatus 104 and the first wireless communication unit 102 transmit a beacon. In the present specific case, the back-off time is 63 μs, and thus the time T5 is reached 72 μs (=135−63 μs) after the self CTS transmission completion time T4. The transmission of the beacons is completed at T6 (transmission completion time) 170.6 μs after T5. The time T6 is in the range covered by the NAV value. Thus, the second wireless communication unit 103, the second wireless communication apparatus 105 and the AP 106 do not perform communication during a period in which the first wireless communication unit is receiving or transmitting a beacon. This allows the first wireless communication unit to receive a WiMedia communication beacon without receiving interference from the wireless LAN communication.

On the other hand, in a case where the result of the monitoring in step S608 indicates that the wireless channel is in use, the processing flow proceeds to step S610.

In step S610, under the control of the CPU 201, the MAC unit 214 cancels the transmission of the self CTS signal because if the self CTS signal is transmitted, a beacon period will start before the completion of the self CTS signal.

The maximum back-off time taken into account in the setting of the time T1 is set to 135 μs so as to be adaptable to first-time transmission. The MAC 214 may detect the retransmission status of the medium, and the maximum back-off time may be changed depending on the retransmission status.

In the example described above, there are two beacon transmission apparatuses. Note that there may be three or more beacon transmission apparatuses. In the case of WUSB, NBD that transmits no WiMedia beacons is allowed in the WiMedia standard, and thus there can be only one beacon transmission apparatus. That is, one of the first wireless communication unit 102 and the WiMedia apparatus 104 may transmit a beacon and the other one may not to transmit a beacon. Note that WUSB stands for Wireless Universal Serial Bus, and NBD stands for Non Beaconing Device.

In this case, the beacon period is given by N×85.3 μs and the NAV value is determined depending on the beacon period. That is, by changing the NAV value depending on the situation, it becomes possible to ensure that the NAV period includes a beacon period. Besides it also becomes possible to prevent communication of the second wireless communication unit from being limited to a greater extent than is necessary.

In the case where the first wireless communication unit 104 transmits no beacon, the timer 210 calculates the start time of the WiMedia beacon period based on a time at which a beacon is received from an external apparatus that performs wireless communication according to the WiMedia standard. More specifically, the start time of the WiMedia beacon period is determined by adding the WiMedia beacon repetition period, i.e., 65,536 ms, to the time at which reception of a beacon appearing earliest in one super frame from the external apparatus is started.

As described above, by transmitting a self CTS signal including a NAV value set to be equal to or greater than a beacon period to the wireless LAN apparatus immediately before the beacon period, it becomes possible to disable transmission in the wireless LAN during the period that is important for WiMedia communication. This prevents a wide-band low-energy signal handled by the WiMedia apparatus from being interfered with by a wireless LAN signal in the same or adjacent frequency band, and thus it is possible to prevent a beacon from being lost which may otherwise occur by interference. Thus it becomes possible for the WiMedia apparatus to perform high-stability communication. On the other hand, the wireless LAN apparatus is not interfered with by periodically appearing WiMedia beacons, and thus it is possible to reduce retransmission of a lost signal that may otherwise be necessary.

In a case where the first wireless communication unit 102 or the WiMedia apparatus 104 is in a power saving mode, a beacon is transmitted only once every several super frames. In such a case, a self CTS signal may be transmitted only in a super frame in which a beacon is transmitted. Instead of transmitting a self CTS signal each time a beacon is received, a self CTS signal may be transmitted once every minimum necessary number of beacons as long as the WiMedia apparatus 104 is allowed to maintain synchronization. This prevents the communication of the second wireless communication unit from being limited to a greater extent than is necessary.

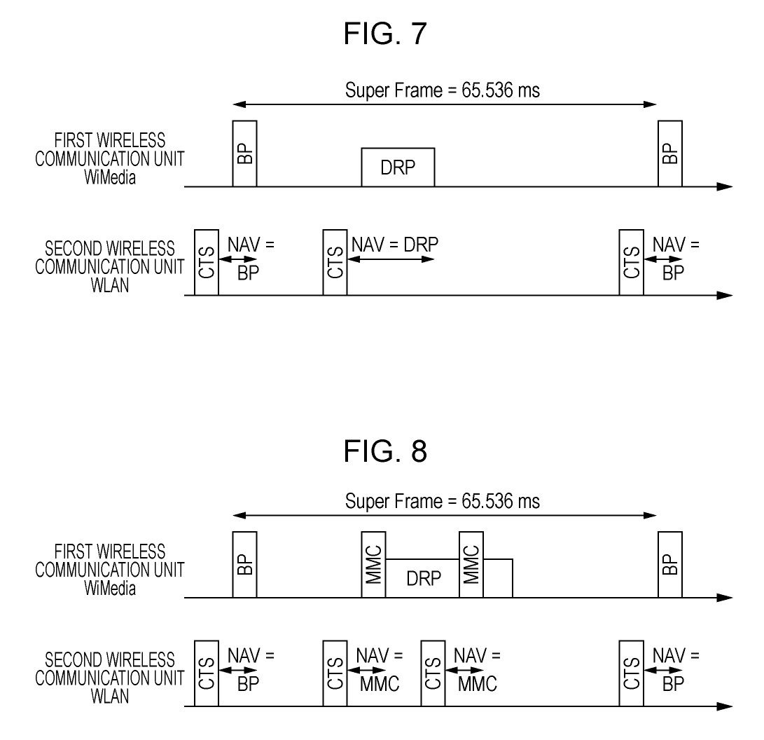

In the example described above, immediately before a WiMedia beacon period, the second wireless communication unit 103 transmits a self CTS signal in which a NAV value equal to or greater than the beacon period is set. Alternatively, as shown in FIG. 7, immediately before the start of DRP, the first wireless communication unit 102 may transmit a self CTS signal in which the NAV value is set to be equal to a DRP period according to the distributed reservation protocol method. Note that DRP stands for Distributed Reservation Protocol. The start time and the period of DRP in the super frame are fixed, and these values are transferred, as with the beacon period, from the first wireless communication unit 102 to the second wireless communication unit 103 thereby implementing the embodiment of the invention. In this case, communication is performed in a time-sharing manner by the WiMedia communication and the wireless LAN communication. This allows a reduction in retransmission by the WiMedia apparatus and the wireless LAN apparatus. In particular, a great effect is obtained when the WiMedia communication has large traffic.

The NAV value described in the self CTS signal may be set to cover at least the start time T1 of the WiMedia beacon. This allows a reduction in the NAV value compared with the example described above. In this case, it is possible to reduce the inhibition of wireless LAN communication after the WiMedia beacon completion time T6. Before communication is started by the second wireless communication unit 103, the STA 105, or the AP 106, the status of the wireless channel is monitored to check whether there is a WiMedia beacon. This ensures that no communication is performed by the wireless LAN apparatus until the WiMedia beacon is completed, and thus the WiMedia beacon is prevented from being interfered with by the communication by the wireless LAN apparatus.

When there is no overlap in frequency band between the first wireless communication system and the second wireless communication system, the operation may be switched into a mode in which no CTS signal is transmitted. This prevents the communication of the second wireless communication system from being limited by the CTS signal in a state in which there is no overlap in frequency band.

In the embodiment described above, communication by the second wireless communication system is disabled during a beacon period of the first wireless communication system. Next, an embodiment is disclosed below in which the first wireless communication system is a WUSB device, and transmission by the second wireless communication system is disabled not only during the beacon period but also during a period of MMC that is a notification signal used in the WUSB system. Note that WUSB stands for Wireless Universal Serial Bus, and MMC stands for Micro Scheduled Management Command.

In the following explanation, similar parts to those in the previous embodiment are not described.

In the present embodiment, connection in a wireless communication system is performed in a similar manner to the first embodiment described above with reference to FIG. 1. More specifically, a WUSB host 104 configured according to the same method as that of the first wireless communication unit 102 serving as the first external apparatus operating as a WUSB device, and the WUSB host 104 is in a state in which it is connected to the first wireless communication unit 102.

The combination apparatus 101 is configured in a similar manner to that according to the previous embodiment described above with reference to FIG. 2. In the present embodiment, the first wireless communication method is according to the WUSB standard, and the MAC unit 209 is configured to control assembling/disassembling of a wireless frame and transmission/reception timing according to the WUSB standard. In the WUSB standard, wireless communication is performed in an upper layer above the WiMedia layer, and thus, in the present embodiment, WUSB is regarded as a different method from WiMedia. The timer 210 is configured to generate a wireless frame timing signal used by the MAC unit 209. The modem 211 has a baseband function to modulate/demodulate a wireless frame according to the WUSB standard employed as the first wireless communication method and also has an RF function to perform a conversion between an RF signal and a baseband signal. The antenna 207 and the first wireless modem 211 are connected via an RF signal. The MAC unit 209 and the first wireless modem 211 are connected via a base band signal. The NAV calculation unit 212 is configured to calculate a transmission-inhibited period in the wireless LAN from a period of a WiMedia beacon or an MMC signal received from the MAC unit 209.

The timer 213 is configured to generate a wireless frame timing signal used by the MAC unit 214. The timer 213 also generates a timing signal indicating timing of transmitting a self CTS signal in the wireless LAN, based on the start time of the WiMedia beacon notified from the timer 210 disposed in the first wireless communication unit.

The MAC unit 214 is configured to control assembling/disassembling of a wireless frame and transmission/reception timing according to the IEEE802.11a standard employed as the second wireless communication method. When the MAC unit 214 receives a self CTS transmission timing signal from the timer 213, the MAC unit 214 starts transmitting a self CTS signal. The modem 215 has a baseband function to modulate/demodulate a wireless frame according to the IEEE802.11a standard employed as the second wireless communication method and also has an RF function to perform a conversion between an RF signal and a baseband signal. The antenna 208 and the second wireless modem 215 are connected via an RF signal. The MAC unit 214 and the second wireless modem 215 are connected via a base band signal.

FIG. 8 is a diagram illustrating a relationship in terms of transmission timing between a period of a WiMedia beacon transmitted by a first wireless communication unit and a period of a self CTS signal transmitted by a second wireless communication unit. Note that the relationship in terms of transmission timing shown in FIG. 8 is that obtained after at least one or more beacons and one or more MMC signals have been received by the first wireless communication unit. FIG. 8 also illustrates a relationship in terms of transmission timing between WUSB MMC signals transmitted by the first wireless communication unit and self CTS signals transmitted by the second wireless communication unit. A WiMedia beacon is transmitted periodically at intervals of 65.536 ms, and a self CTS signal is transmitted immediately before the start of each beacon. The NAV value indicating the period during which transmission is inhibited is described in the self CTS signal in a similar manner to the first embodiment described above such that the wireless LAN apparatus is inhibited from performing transmission during the beacon period.

The WUSB device can determine the timing of a next MMC signal only after a preceding MMC signal has been received. Therefore, in an operation cycle in which a MMC signal is received for the first time, it is impossible to transmit a self CTS signal to protect this MMC signal. In following operation cycles, the timer 210 determines the MMC start time from the received MMC signal, and the time 210 notifies the timer 213 of the determined MMC start time. According to the notified MMC start time, the timer 213 generates a self CTS transmission timing signal.

The MAC unit 209 determines the length of the received MMC signal and notifies the NAV calculation unit 212 of it. According to the notified MMC length, the NAV calculation unit 212 sets the NAV value such that the wireless LAN apparatus is inhibited from performing transmission during a period equal to or greater than the MMC length. In the present embodiment, the MMC length is set to 256 μs corresponding to the length of one MAS. Note that MAS stands for Media Access Slot, which is one of 256 slots obtained by dividing one super frame.

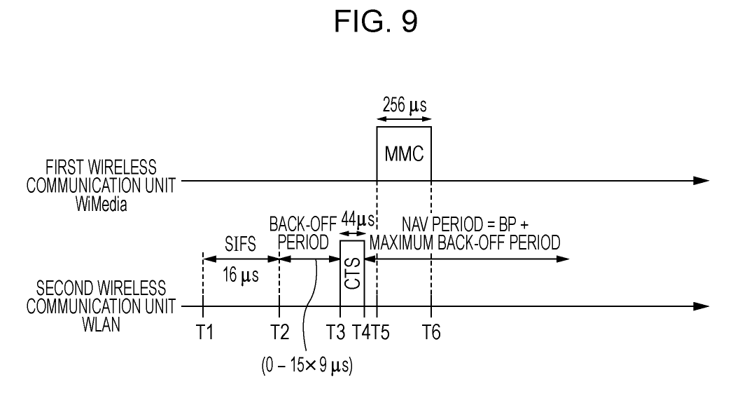

FIG. 9 illustrates in more detail the relationship in terms of timing between the MMC signal and the self CTS signal. The length of the MMC signal depends on the data size of IE (Information Element) attached to the MMC signal to indicate a channel assigned to each WUSB device, a connection/disconnection status, etc. In the present specific situation, there is no WUSB device located nearby, and the WUSB host 104 is maintained in connection with the first wireless communication unit 102. In this state, a great change in the length of IE attached to the MMC signal does not occur, and thus the NAV value is fixed. However, in a case where the number of WUSB devices being in connection varies, it is necessary to correspondingly change the NAV value.

For example, each time MMC signal is received, the NAV value is set to the length described in the MMC signal. This makes it possible to protect MMC signals while adapting to the change in the number of WUSB devices being in connection. The NAV value may be set to the maximum length of a received MMC signal. This makes it possible to protect a MMC signal in a more reliable manner.

The MMC start time T5 is managed by the timer 210. The MMC signal is received by the first wireless modem 211. From a Next-MMC-Time field in a header of this MMC signal, the timer 210 detects the MMC reception start time T5 at which receiving of a next MMC signal will be started. The time 210 notifies the time 213 of the next MMC reception start time T5.

As in the first embodiment described above, the timer 213 calculates the time T1 at which to start preparation for transmission of the self CTS signal, which is to be informed to the MAC unit 214 from the timer 213. In the present embodiment, the time T1 is 195 μs before T5.

The NAV calculation unit 212 determines the NAV value as 391 μs, which is given by the sum of the MMC transmission time 256 μs and the maximum back-off time 135 μs. Thus, the NAV period always includes the MMC transmission period regardless of the initial value of the back-off time that is set randomly. In a case where the counting-down by the back-off counter is temporarily stopped because the medium is busy or for other reasons over a period longer than the difference between the maximum back-off value and the initial value, or in a case where after count value of the back-off counter reaches 0, the medium is still in a busy state, and thus a further delay is needed in transmission of the self CTS signal, the transmission of the self CTS signal is canceled.

Next, the operation of the combination apparatus 101 according to the present embodiment is described below. In the following explanation, it is assumed that the combination apparatus 101 is in a state in which the first wireless communication unit 102 is connected to the WUSB host 104 and the second wireless communication unit 103 is connected to the AP 106.

The operation of transmitting a self CTS signal before a WiMedia beacon is performed in a similar manner to the first embodiment described above, and thus a duplicated description thereof is omitted.

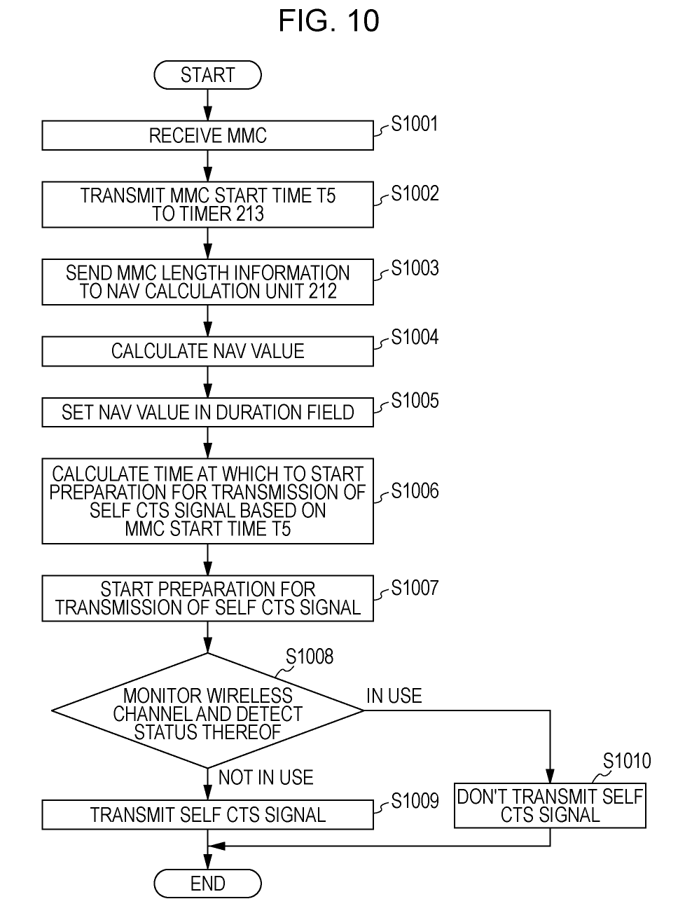

The operation of transmitting a self CTS signal for a MMC signal to be transmitted by the WUSB host 104 is explained below with reference to a flow chart shown in FIG. 10. Note that the process of this flow chart shown in FIG. 10 is performed by the CPU 201 according to a program stored in the ROM 202.

In step S1001, under the control of the CPU 201, the first wireless modem 211 receives a MMC signal.

In step S1002, under the control of the CPU 201, the timer 210 detects a next MMC start time T5 described in the Next-MMC-Time field of the received MMC signal, and notifies the timer 213 of the detect MMC start time T5.

In step S1003, under the control of the CPU 201, the MAC unit 209 detects the length of the received MMC signal (256 μs in this specific example) and sends MMC length information indicating the detected length to the NAV calculation unit 212.

In step S1004, under the control of the CPU 201, the NAV calculation unit 212 adds the maximum back-off value to the MMC time thereby determining the NAV value for the self CTS signal.

In step S1005, under the control of the CPU 201, the NAV calculation unit 212 sets the determined NAV value in the duration field 604.

In step S1006, under the control of the CPU 201, the timer 213 generates a timing signal indicating the time T1 that is ahead of the MMC start time T5 by an amount equal to the period needed to transmit the self CTS signal.

In step S1007, under the control of the CPU 201, when the time T1 is reached, the timer 213 instructs the MAC unit 214 to start preparation for the transmission of the self CTS signal in which the NAV value is set in the above-described manner.

In step S1008, under the control of the CPU 201, the MAC unit 214 monitors the usage status of the wireless channel during the SIFS period with a length of 16 μs. Herein, let us assume by way of example that the back-off time is 63 μs. If the monitoring indicates that the wireless channel is not in use, then the processing flow proceeds to step S1009.

In step S1009, under the control of the CPU 201, the MAC unit 214 transmits the self CTS signal. The NAV value set in the self CTS signal is equal to the sum of the MMC time and the maximum back-off time, i.e., 256+15×9=391 μs, and thus communication with the STA 105 and the AP 106 is disabled during a period of 391 μs after the time T4 at which the transmission of the self CTS signal is completed.

Thereafter, if the MMC start time T5 is reached, the WiMedia apparatus 104 transmits the MMC signal. In this specific example, the back-off time is 63 μs and thus the MMC start time T5 is reached when 72 (=135−63) μs has elapsed since the transmission completion time T4 of the self CTS signal with NAV=391 μs, and the WiMedia apparatus 104 transmits the MMC signal. When 256 μs has further elapsed since the start of the transmission, the transmission completion time T6 is reached. The time T6 is in the range covered by the NAV value. Therefore, during the period in which the first wireless communication unit 102 is receiving the MMC signal, the second wireless communication unit 103, the STA 105, and the AP 106 do not perform communication. Thus, the first wireless communication unit 102 is allowed to receive the beacon without interfering with the second wireless communication system.

On the other hand, in the case where the monitoring in step S1008 indicates that the wireless channel is in use, the processing flow proceeds to step S1010.

In step S1010, under the control of the CPU 201, the MAC unit 214 cancels the transmission of the self CTS signal.

The maximum back-off time taken into account in the setting of the time T1 is set to 135 μs so as to be adaptable to first-time transmission. The MAC unit 214 may detect the retransmission status of the medium, and the maximum back-off time may be changed depending on the retransmission status.

In the example described above, when the time T1 is reached, the timer 213 instructs the MAC unit 214 to start preparation for the transmission of the self CTS signal. Alternatively, the MAC unit 214 may manage the time and the MAC unit 214 itself may control the starting of the preparation for the transmission of the self CTS signal. In this case, the MAC unit 214 acquires information about the time T5 from the timer 210.

The NAV value described in the self CTS signal may be set so as to cover at least the MMC start time T1. In this case, the NAV value can be smaller than in the first embodiment. This allows a reduction in inhibition of wireless LAN communication after the MMC completion time T6. Before communication is started by the second wireless communication unit 103, the STA 105, or the AP 106, the status of the wireless channel is monitored to check whether there is a MMC signal. This ensures that no communication is performed by the wireless LAN apparatus until the MMC signal is completed, and thus the MMC signal is prevented from being interfered with by the communication by the wireless LAN apparatus.

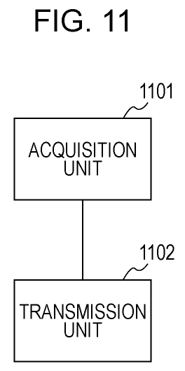

The communication apparatus 101 may be configured as shown in a functional block diagram of FIG. 11.

In FIG. 11, reference numeral 1101 denotes an acquisition unit configured to acquire a reception start time at which a signal (such as a beacon signal) is to be transmitted by the WiMedia apparatus 104. Reference numeral 1102 denotes a transmission unit configured to transmit a CTS signal to an external apparatus (STA 105 or AP 106) according to the IEEE802.11a standard during a period including the receiving timing acquired by the acquisition unit 1102.

As described above, immediately before the beacon receiving period and/or immediately before the MMC receiving period, the self CTS signal in which the NAV value equal to the beacon period and the MMC period is set is transmitted to the wireless LAN apparatus, thereby controlling the wireless LAN apparatus not to perform the communication during the beacon period and/or the MMC period that are important to maintain the WUSB communication. This prevents a wide-band low-energy signal handled by the WiMedia apparatus from being interfered with by a wireless LAN signal in the same or adjacent frequency band, and thus it is possible to prevent a beacon or an MMC signal from being lost which may otherwise occur by interference. Thus it becomes possible for the WUSB apparatus to perform high-stability communication. Besides, the wireless LAN apparatus is not interfered with by beacon transmission or MMC transmission, and thus it is possible to reduce retransmission of a lost signal that may otherwise be necessary.

Furthermore, the second wireless communication unit generates a self CTS timing signal a particular period before a first signal (beacon, DRP, MMC, etc) is received by the first wireless communication unit, thereby ensuring that transmission of a second signal (self CTS signal) is completed before the start time of a beacon period.

The NAV calculation unit sets the NAV value such that the signal received by the first wireless communication unit is within the NAV period regardless of the back-off time that is set randomly. That is, the NAV period is set so as to include the period of the signal received by the first wireless communication unit.

The NAV value is also set so as to cover at least the start time of the signal received by the first wireless communication unit thereby preventing communication of the second wireless communication unit from being limited to a greater extent than is necessary after the receiving of the signal is completed. Before the second wireless communication unit starts communication, the second wireless communication unit checks the status of the wireless channel to determine whether the signal is being received. This ensures that no communication is performed by the second wireless communication unit until the receiving of the signal is completed and thus the signal being received by the first wireless communication unit is prevented from being interfered with by the communication by the second wireless communication unit.

In the case where the counting-down by the back-off counter is temporarily stopped because the wireless channel is in use or for other reasons over a period longer than the difference between the maximum back-off value and the initial value, and thus a great delay is needed in transmission of the self CTS signal, the transmission of the self CTS signal is canceled. Also in the case where when the back-off counter reaches 0, a further delay is necessary in transmission of the self CTS signal because the wireless channel is still in use or for any other reason, the transmission of the self CTS signal is canceled. Thus, the signal received by first wireless communication unit is prevented from being interfered with by transmission of the self CTS signal.

The NAV value is changed depending on the period of the signal received by the first wireless communication unit thereby ensuring that the NAV period includes the beacon period regardless of a change in situation. Besides it also becomes possible to prevent communication of the second wireless communication unit from being limited to a greater extent than is necessary.

In the embodiments described above, the beacon period and the MMC period are protected by transmitting the self CTS signal. In addition, an in-transaction period and an out-transaction period used by an apparatus may be protected by using a self CTS signal in a similar manner.

In the case where the first wireless communication unit 102 is a WUSB host and the WiMedia apparatus 104 is a WUSB device, information indicating the MMC transmission timing is given in advance to the first wireless communication unit 102. Therefore, it is not necessary to detect the next MMC reception timing from the Next-MMC-Time field, but it is possible to notify the timer 213 of the MMC timing from the beginning.

The first wireless communication system may be a Bluetooth device. In this case, in addition to the beacon period, a Bluetooth communication period may be protected by transmitting a self CTS signal.

In the embodiments described above, the first wireless communication unit 102 and the second wireless communication unit 103 are disposed in the same single case. Note that the first wireless communication unit 102 and the second wireless communication unit 103 are not necessarily needed to be disposed in the same single case, as long as the second wireless communication unit 103 can acquire information associated with the time and the period of the notification signal used in the first wireless communication system.

The embodiments of the present invention may be realized by storing, in a storage medium, a software program code implementing any one or more functions described above and supplying the storage medium to a system or an apparatus whereby a computer (CPU or MPU) in the system or apparatus reads and executes the program code stored in the storage medium. In this case, it should be understood that the program code read from the storage medium implements the functions of invention and thus the storage medium storing the program code falls within the scope of present invention.

Storage media which may be employed in the present invention to supply the program code include a floppy disk, a hard disk, an optical disk, a magneto-optical disk, a CD-ROM, a CD-R, a magnetic tape, a non-volatile memory card, a ROM, and a DVD.

In the implementation of the functions by executing the program code on the computer, an OS running on the computer may perform part or all of the process according to the program code. Note that OS stands for Operating System.

The program code stored in the storage medium may be loaded into a memory of an extension card inserted in the computer or into a memory of an extension unit connected to the computer, and part or all of the process may be performed by a CPU disposed on the extension card or the extension unit in accordance with the loaded program code thereby achieving the functions of the invention.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-248072 filed Sep. 26, 2008, which is hereby incorporated by reference herein in its entirety.

What is claimed is:

1. A communication apparatus comprising:
an acquisition unit configured to acquire information indicating a reception start timing of a signal transmitted by a first apparatus according to a first wireless communication method; and
a transmission unit configured to transmit a signal to a second apparatus capable of performing communication according to a second wireless communication method different from the first wireless communication method whereby the signal controls the second apparatus not to transmit a signal according to the second wireless communication method during a period including the reception start timing indicated by the information acquired by the acquisition unit.

2. The communication apparatus according to claim 1, wherein the transmission unit transmits a signal to control the second apparatus not to transmit the signal according to the second wireless communication method also during a period in which a signal according to the first wireless communication method is transmitted by the communication apparatus.

3. The communication apparatus according to claim 1, wherein:
the acquisition unit acquires information indicating a reception period from a reception start timing to a reception completion timing of a signal transmitted by one or more apparatuses according to the first wireless communication method; and
the transmission unit transmits a signal to control the second apparatus not to transmit the signal according to the second wireless communication method over the entire reception period.

4. The communication apparatus according to claim 1, wherein the signal transmitted by the transmission unit is a signal whose destination is set to the communication apparatus whereby the signal also controls the communication apparatus not to transmit a signal according to the second wireless communication method.

5. The communication apparatus according to claim 1, wherein the reception start timing indicated by the information acquired by the acquisition unit is a reception start timing of a notification signal transmitted according to the first wireless communication method.

6. The communication apparatus according to claim 1, wherein the acquisition unit acquires information indicating a reception timing of a next signal transmitted according to the first wireless communication method, the information being included in a previous signal received according to the first wireless communication method.

7. The communication apparatus according to claim 1, wherein the reception start timing is a reception start timing of a signal received in a reserved period according to the first wireless communication method.

8. The communication apparatus according to claim 1, wherein the first wireless communication method is a method according to the WiMedia standard, and the second wireless communication method is a method according to the IEEE802.11 series standard.

9. The communication apparatus according to claim 1, wherein the first wireless communication method is a method according to the WUSB standard, and the second wireless communication method is a method according to the IEEE802.11 series standard.

10. A communication apparatus comprising:
an acquisition unit configured to acquire information indicating a reception timing of each of signals transmitted by a first apparatus according to a plurality of wireless communication methods; and
a transmission unit configured to transmit a signal to a second apparatus capable of performing communication according to a wireless communication method different from any of the plurality of wireless communication methods whereby the signal controls the second apparatus not to transmit a signal according to the different wireless communication method during a period including any reception timing indicated by the information acquired by the acquisition unit.

11. The communication apparatus according to claim 10, wherein the reception timing is a reception start timing of the signal received according to each of the plurality of wireless communication methods.

12. The communication apparatus according to claim 10, wherein the reception timing is a period from a reception start timing to a reception completion timing of the signal received according to each of the plurality of wireless communication methods.

13. The communication apparatus according to claim 10, wherein the plurality of wireless communication methods are a method according to the WiMedia standard and a method according to the WUSB standard, and the second wireless communication method is a method according to the IEEE802.11 series standard.

14. A method for controlling a communication apparatus, comprising:
acquiring information indicating a reception start timing of a signal transmitted by a first apparatus according to a first wireless communication method; and
transmitting a signal to a second apparatus capable of performing communication according to a second wireless communication method different from the first wireless communication method to control the second apparatus not to transmit a signal according to the second wireless communication method during a period including the reception start timing indicated by the information acquired in the acquiring.

15. A method for controlling a communication apparatus, comprising:
acquiring information indicating a reception timing of each of signals transmitted by a first apparatus according to a plurality of wireless communication methods; and
transmitting a signal to a second apparatus capable of performing communication according to a wireless communication method different from any of the plurality of wireless communication methods to control the second apparatus not to transmit a signal according to the different wireless communication method during a period including any reception timing indicated by the information acquired in the acquiring.

16. A recording medium which stores programs which makes a computer function as the communication apparatus set forth in claim 1.

17. A recording medium which stores programs which makes a computer function as the communication apparatus set forth in claim 10.
